(19) United States
(12) Patent Application Publication
(10) Pub. No.: US 2019/0061370 A1
(43) Pub. Date: Feb. 28, 2019

(54) THERMAL TRANSFER PRINTER AND CABLE TIE THEREFOR

(71) Applicant: HELLERMANNTYTON GMBH, Tornesch (DE)

(72) Inventors: Lukas Haase, Moorrege (DE); Patrick Stiewe, Lagerdorf (DE)

(21) Appl. No.: 15/768,974

(22) PCT Filed: Oct. 21, 2016
(86) PCT No.: PCT/EP2016/075461

§ 371 Date: Apr. 17, 2018

(30) Foreign Application Priority Data
Oct. 23, 2015 (DE) 202015007411.1

(51) Int. Cl. B41J 2/325; B41J 3/407

(52) U.S. Cl. CPC B41J 2/325; B41J 3/407

(57) ABSTRACT

A thermal transfer printer having a pressing roll and a thermal printing head. The thermal transfer printer is configured to pass pre-aligned cable ties through a gap formed between the pressing roll and the thermal printing head and to imprint a labeling section of a respective cable tie by means of a transfer film likewise passed through the gap. The gap for passage of a respective cable tie head has a partial cross-sectional expansion in the feed-through direction through the gap.

### CROSS-REFERENCE TO RELATED APPLICATIONS

This application is a national stage application under 35 U.S.C. § 371 of PCT Application Number PCT/EP2016/075461 having an international filing date of Oct. 21, 2016, which designated the United States, said PCT application claiming the benefit of German Utility Model Application No. 20 2015 007 411.1, filed Oct. 23, 2015, the entire disclosure of each of which are hereby incorporated herein by reference.

### TECHNICAL FIELD OF THE INVENTION

The present invention relates to a thermal transfer printer and a cable tie for use with the thermal transfer printer.

### BRIEF DESCRIPTION OF THE SEVERAL VIEWS OF THE DRAWING

Characteristics and advantages of the invention shall appear upon reading the detailed description and the appended drawings, in which:

FIG. 1 shows a view of a thermal transfer printer with cable ties arranged thereon in accordance with one embodiment of the invention;

FIG. 2 shows a front view of the printing gap of a thermal transfer printer in accordance with one embodiment of the invention;

FIG. 3 shows a sectional view of cable ties which are belt-linked and to be imprinted with the thermal transfer printer; in accordance with one embodiment of the invention.

FIG. 4 shows a side view of the cable tie of FIG. 3 in accordance with one embodiment of the invention; and

FIG. 5 shows a front view of the printing gap of a thermal transfer printer with cable tie received therein in accordance with one embodiment of the invention.

### DETAILED DESCRIPTION OF THE INVENTION

A thermal transfer printer with a pressing roll and a thermal printing head is presented. The thermal printing head, in particular extending strip-shaped in a printing gap direction, may have a plurality of separately controllable heating elements, in particular computerized controllable heating elements, to transfer a printed image to an object to be imprinted. The pressing roll, which in particular is arranged opposite the thermal printing head, in particular under joint formation of the (printing) gap, is provided to act upon objects to be imprinted with a designated contact force, in particular to transport the same. Preferably, the thermal transfer printer comprises a drive mechanism for the pressing roll, for example in the form of an electric motor.

The thermal transfer printer is further configured to pass the pre-aligned cable ties through the gap or printing gap formed between the pressing roll and the thermal printing head. In the preferred pre-alignment, the cable ties passing through the gap extend with their longitudinal extension direction in the longitudinal extension direction of the gap, i.e. the width direction of the cable ties corresponds to the feed-through direction through the gap. In this case, it is particularly desirable that the cable ties are received in the gap substantially over their entire length.

The thermal transfer printer may further comprise positioning means for positioning the cable ties with the intended pre-alignment at the gap or also conveying them to the gap. For example, the pressing roll may have carrier or engaging elements for this purpose. It is generally preferred, in particular with regard to a non-complex pre-alignment, to provide the cable ties to be imprinted belt-linked for use with the thermal transfer printer.

According to the invention it is envisioned to imprint a labeling section of a respective cable tie by means of the thermal transfer printer, for which a transfer film also passing through the gap is provided. The transfer film is a film coated with temperature-sensitive ink, which herein is passed between the thermal printing head and the cable ties through the gap—preferably as web. When a heating element of the thermal printing head is controlled and its head heated, the ink layer in the film is softened and can be transferred to the imprinting object (the cable tie), which is urged against the film by the pressing roll. An exact color imprint and a precise print quality can be achieved. A labeling section of a respective cable tie may be provided as labeling section, for example as tab, flag or as plate-shaped section.

In particular, in order to be able to guide the cable ties unhindered, but always reliably aligned and supported by the gap, in particular completely, thus allowing an optimum printing result, the gap in the presented thermal transfer printer further comprises a partial cross-sectional expansion for passage of a respective cable tie head in the feed-through direction through the gap. In this case, the partial cross-sectional expansion is formed in particular—viewed in the longitudinal extension direction of the gap—next to or outside that area which is overlapped by the transfer film in the gap. The thermal transfer printer according to the invention is thus advantageously able to imprint cable ties directly and precisely, so that affixing of imprinted labels onto the cable ties is no longer necessary.

Preferably, the partial cross-sectional expansion of the gap is formed by at least one recess on the thermal printing head, extending (in forming the gap) in longitudinal extension direction of the gap in particular strip-shaped, for example in a sheet thereof, alternatively, for example, by means of at least one recess on the pressing roll. Configurations are also conceivable in which both the thermal printing head and the pressing roll have a partial cross-sectional expansion for the passage of respective cable tie heads. In this case, a thermal transfer printer may be provided, in which respective cable tie heads may be aligned, as they pass through the gap, protruding in the direction of the pressing roll or protruding in the direction of the thermal printing head.

Simple embodiments of the thermal transfer printer provide that the partial cross-sectional expansion is formed by a groove at the pressing roll or by a groove in the thermal printing head. In this case, the groove at the pressing roll may be a groove in the circumferential direction of the same, i.e. a circumferential groove or annular groove, a groove in the thermal printing head, for example, a groove in the transverse direction of the gap or in the feed-through direction of the cable ties.

Preferred embodiments of the thermal transfer printer further provide that the thermal transfer printer at opposite end sections of the pressing roll or of the thermal printing head each have a recess to form a partial cross-sectional expansion for the passage of a cable tie head. In this case, the cable ties passing through the gap may be aligned such that the head of one cable tie points in the direction of a first longitudinal gap end and the head of a subsequently passing cable tie points in the direction of a second longitudinal gap end (i.e. the cable ties passing through the gap are offset by 180° to each other), so that the pre-alignment of the cable ties with regard to the space requirements, in particular belt-linked, can be carried out efficiently.

Further presented is a cable tie for use with a thermal transfer printer as discussed above, wherein the cable tie has a binding section and a labeling section wherein the binding section and the labeling section have the same thickness. With this embodiment of the cable tie, a maximized contact surface and optimum support when imprinted in the gap is achievable, thus allowing good print quality. In general, it may further be provided that the head of the cable tie is formed on the labeling section opposite the binding section, in particular forming a hinge joint.

With the cable ties which, as already noted, are preferably provided in belt-linked form, the belts preferably also have a height which corresponds to that of the binding section and the labeling section. As a result, the gap outside the partially expanded cross-section can be provided advantageously and structurally uncomplicated with a continuously uniform cross-section.

Further features and advantages of the invention will become apparent from the following description of embodiments of the invention, with reference to the figures of the drawings illustrating details essential to the invention, and from the claims. The individual features may be implemented individually for themselves or in a plurality of different combinations in a variant of the invention.

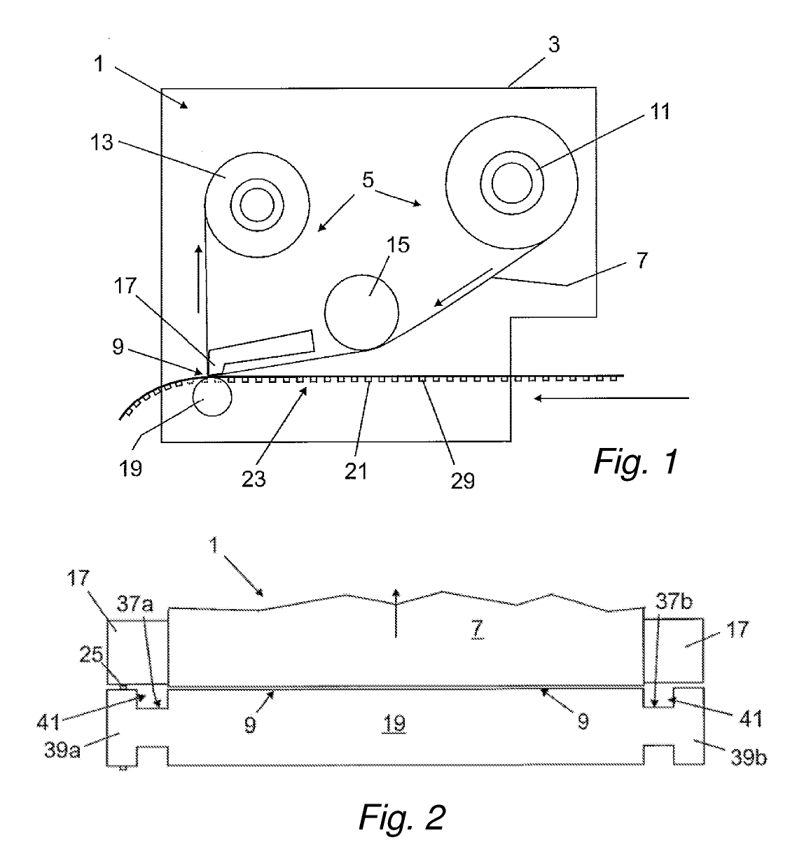

FIG. 1 shows, by way of example and schematically, a thermal transfer printer 1 having a printer housing 3, in which a film web transport device 5 is accommodated, by means of which a transfer film 7 may be conveyed through a printing gap or gap 9 of the thermal transfer printer 1. The film web transport device 5 comprises a first roll 11, which is provided for unwinding of the transfer film 7, further a second roll 13, which is provided for winding-up of the transfer film 7 after printing operation. A third roll 15 is provided to guide the transfer film web to the gap 9, with proper inclination being set, i.e. in the sense of a guide pulley.

The thermal transfer printer 1 further comprises a thermal printing head 17 which, together with a pressing roll 19 arranged underneath or opposite thereto, forms the gap 9 or printing gap. The gap 9 extends over the entire length of the pressing roll 19, i.e. the pressing roll 19 is overlapped over its entire length by the strip-shaped thermal printing head 17 extending over it to form the gap 9.

As can be seen, the guiding support of the transfer film 7 through the gap 9 is provided, which is deflected after passing through the 9—in the intended feed-through direction (arrows in FIG. 1)—at the thermal printing head 17 toward the second roll 13, i.e. for its wind-up.

In order to guide objects to be imprinted, in the present invention in particular cable ties 21 to be imprinted, toward or through the gap 9, i.e. between the transfer film 7 abutting against the thermal printing head 17 and the pressing roll 19, the pressing roll 19 is driven, for that the thermal transfer printer 1 comprises, for example, an electric drive unit (not shown). The cable ties 21 may further be supplied to the thermal transfer printer 1 by a feed device (not shown), for example by a supply roll or e.g. from a magazine. The feed device may be part of the thermal transfer printer 1 or e.g. be separate from it.

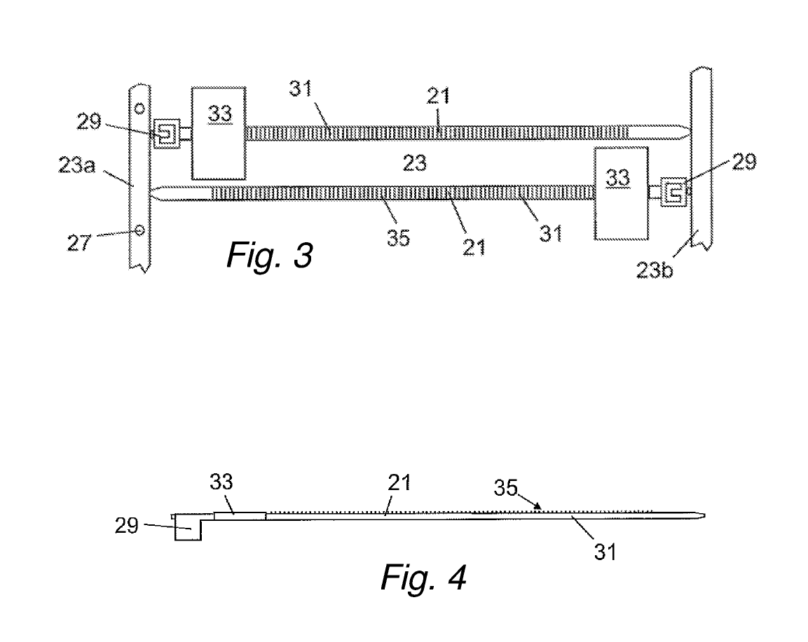

As illustrated in FIG. 3, the cable ties 21 to be imprinted are preferably joined or belt-linked to form a (continuous) strand 23, wherein the cable ties 21 are received in particular between two belts 23a, 23b and are each supported by it at their (longitudinal) end. Here advantageously, a 180° offset of successive cable ties 21 may reduce the longitudinal extent of the two belts 23a, 23b required for their reception. In addition, however, an individual supply of the cable ties 21 to the printing gap is conceivable, for example, a pre-alignment of a respective cable tie with a positioning device.

For the pre-alignment and the transport or passage through the gap 9, the pressing roll 19 comprises carrier elements 25 which are arranged on the edge in the form of e.g. engaging pins or cams. The carrier elements 25 may cooperate with corresponding engaging elements 27, for example recesses, of at least one belt 23a, i.e. to position the belt-linked cable ties 21 pre-aligned in the printing gap. A passage of the belt-linked cable ties 21 through the gap 9 is hereby provided in the longitudinal extension direction of the strand 23, wherein the longitudinal extension direction of the cable ties 21 coincides with the longitudinal extension direction of the gap 9.

As illustrated, for example, in FIG. 3, a respective cable tie 21 comprises a cable tie head 29 and a binding section 31, between which a labeling section 33 of the cable tie 21 is formed integrally with the cable tie head 29 and the binding section 31. Between the binding section 31 and the cable tie head 29 a hinge connection or a material taper may be provided, in particular to improve the flexibility of the cable tie 21. The labeling section 33 is provided as label field, for example, formed in a plate or tab form.

In the embodiment of the cable tie 21 according to FIGS. 3 and 4, it is provided as externally toothed cable tie 21, so that the toothed side 35 does not rest on a bundled material when being looped in. The cable tie head 29 of the cable tie 21 extends opposite to the toothed side 35 away from the plane of the binding section 31.

Particularly as illustrated in FIG. 2, in this embodiment according to the invention, the pressing roll 19 of the thermal transfer printer 1 further comprises a circumferentially extending groove 37a, 37b adjacent to a respective longitudinal end 39a, 39b such that the (printing) gap 9 formed by the pressing roll 19 is subject to a partial cross-sectional expansion 41. The partial cross-sectional expansion 41 causes, according to the invention, a respective cable tie head 29 to pass unhindered through the gap 9 in the feed-through direction.

As can be seen, the partial cross-sectional expansion 41 is further positioned such that a belt guide adjacent to the same is possible on longitudinal ends 39a, 39b of the pressing roll 19, and further an abutment of the labeling section 33 and the binding section 31 on the pressing roll 19 and the thermal printing head 17 over substantially the entire longitudinal extension of the cable ties, i.e. in the longitudinally central area of the pressing roll 19 between the partial cross-sectional expansion 41. It should be noted that the pressing roll 19 with the exception of the partial cross-sectional expansions 41 otherwise has substantially the same cross-section or diameter. Further, it should be noted that the transfer film 7 only overlaps the area of the pressing roll 19 between the partial cross-sectional expansion 41, see FIG. 2.

In particular, in connection with an embodiment of the cable ties 21 in such a way, see FIG. 4, that they have uniform thickness both over the labeling section 33 and over substantially the entire binding section 31, the cable tie 21 in the gap 9 may be firmly supported over almost its entire length with the thermal transfer printer 1, so that a precise and considerable print result is achievable. In the embodiment of the thermal transfer printer 1 according to FIGS. 1 and 2, in particular using the cable ties 21 shown in FIGS. 3 and 4 as discussed above, an imprint on the toothed side 35 is accomplished.

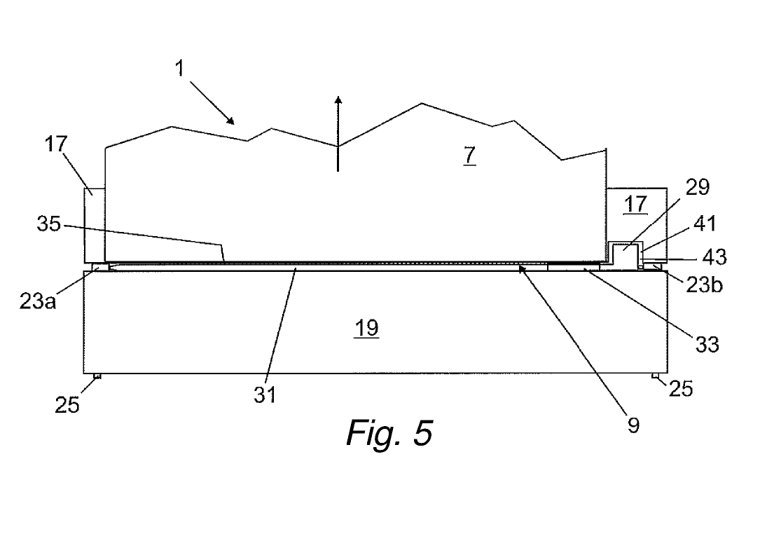

FIG. 5 illustrates another example embodiment of a thermal transfer printer 1 according to the invention, wherein, as in FIG. 2, the arrangement of pressing roll 19 and thermal printing head 17 is illustrated, in particular together with a cable tie 21 received in the gap 9 and the transfer film 7.

In contrast to the embodiment described above, with the thermal transfer printer 1 of FIG. 5, internally toothed cable ties 21 may be imprinted, in which the cable tie head 29 with the intended orientation for imprinting protrudes toward the thermal printing head 17. To enable the cable tie head 29 to pass unhindered through the gap 9, in this embodiment the thermal transfer printer 1 has a partial cross-sectional expansion 41 in the form of a groove 43 on the strip-shaped thermal printing head 17, which enables passage of the cable tie head 29 with the intended pre-alignment when imprinting. In this case, the groove 43 may extend in the feed-through direction of the cable ties 21 in the thermal printing head 17, i.e. as a longitudinal groove. Here, too, it is preferred that the binding section 31 and the labeling section 33 have the same thickness for uniform support in the gap 9, wherein here also the transfer film 7 does not overlap the partial cross-sectional expansion 41.

It should be noted that in the context of the present invention, other embodiments of a thermal transfer printer 1, although not explicitly shown, are conceivable and advantageous, which have a partial cross-sectional expansion 41 both by means of a recess in the pressing roll 19 and a recess in the thermal printing head 17. With such configurations, imprinting can optionally be achieved on externally and also on internally toothed types of cable ties 21 (the imprinting preferably being such that the labeling on the labeling section 33 is readable after application of the cable tie 21). Preferably, the cable ties 21 in the embodiment of the present invention may be made of plastic.

1. A cable stripping tool for use with electrical cables comprising an inner core and an outer sheath, said cable stripping tool comprising:
a body including a cable retaining portion having a rotational axis defined therethrough, wherein the cable retaining portion is configured to receive a cable such that a longitudinal axis of the cable is coaxial with the rotational axis; and
first and second cutting blades movable transversely relative to the rotational axis between a retracted position and a cutting position, the first and second cutting blades each having a blade edge;
wherein the blade edge of the first and second cutting blades are axially spaced from each other relative to the rotational axis and are arranged such that, in the cutting position, the first cutting blade is spaced a first radial distance from the rotational axis and the second cutting blade is spaced a second radial distance from the rotational axis that is greater than the first radial distance, wherein the cable stripping tool is rotatable about the rotational axis when the first and second cutting blades are in the cutting position to cause the first and second cutting blades to cut the outer sheath around an entire circumference of the cable.

2. The cable stripping tool according to claim 1, wherein the cable retaining portion includes a stop member arranged to longitudinally locate the cable when inserted into the cable retaining portion.

3. The cable stripping tool according to claim 2, wherein the first cutting blade is longitudinally closer to the stop member than the second cutting blade.

4. The cable stripping tool according to claim 2, wherein the cable retaining portion comprises a channel extending into a body section having an opening at located at one end configured to receive the cable and am opposing end that is closed, thereby forming the stop member.

5. The cable stripping tool according to claim 4, wherein the channel comprises a plurality of longitudinally extending and annularly spaced ribs.

6. The cable stripping tool according to claim 4, further comprising a blade actuator pivotally mounted to the body section, wherein the first and second cutting blades are mounted to the blade actuator, and wherein pivoting of the blade actuator relative to the body section moves the first and second cutting blades between the retracted position and the cutting position.

7. The cable stripping to according to claim 6, wherein the body section includes a cylindrical wall defining an aperture through the body section having an aperture axis parallel with and spaced from the rotational axis, the blade actuator being pivotally mounted about the cylindrical wall.

8. The cable stripping tool according to claim 7, further comprising the stop member arranged to limit a rotational movement of the blade actuator between the retracted position and the cutting position.

9. The cable stripping tool according to claim 8, wherein the stop member extends from the cylindrical wall and is received with a corresponding channel in the blade actuator having a length defining stop limits.

10. The cable stripping tool according to claim 7, wherein the cylindrical wall is configured to receive a user's finger and an inner surface of the cylindrical wall defines a curved contact surface configured to engage the user's finger to rotate the cable stripping tool around the cable.

11. The cable stripping tool according to claim 6, wherein the first and second cutting blades are circular and arranged concentrically, wherein the first cutting blade has a diameter greater than the second cutting blade, and wherein a central axis of the first and second cutting blades is parallel with the rotational axis.

12. The cable stripping tool according to claim 11, wherein the first and second cutting blades are spaced from a pivotal axis of the blade actuator such that the central axis of the first and second cutting blades pivots along an arcuate path that intersects the rotational axis.

13. The cable stripping tool according to claim 12, wherein the blade actuator is housed within the body and includes a trigger portion that projects out of the body section and is arranged to be depressed by a user to move the first and second cutting blades to the cutting position.

14. The cable stripping tool according to claim 4, wherein the first and second cutting blades are movable between the retracted position, an intermediate cutting position and the cutting position and wherein a radial distance of the first and second cutting blades from the rotational axis is greater at the intermediate cutting position than the cutting position.

15. The cable stripping tool according to claim 14, further comprising a blade actuator to which the first and second cutting blades are mounted, wherein movement of the blade actuator relative to the body section moves the first and second cutting blades between the retracted position, the intermediate cutting position, and the cutting position, said cable stripping tool further comprising a releasable locking element arranged such that movement of the blade actuator from the retracted position to an intermediate position the locking element locks the blade actuator in the intermediate cutting position, thereby preventing return to the retracted position, and further movement of the blade actuator to the cutting position causes the locking element to lock the blade actuator in the cutting position, thereby preventing return to the intermediate cutting position.

16. The cable stripping tool according to claim 15, wherein the locking element comprises a releasable ratchet arrangement including a first set of teeth connected to the body section and a second set of teeth mounted to the blade actuator, one of the first and second set of teeth being movable to release the ratchet arrangement.
